(19) United States
(12) Patent Application Publication
(10) Pub. No.: US 2006/0257284 A1
(43) Pub. Date: Nov. 16, 2006

(54) Verification device and method for optical inspection machine

(76) Inventors: Gary Rheinheimer, Goshen, IN (US); Chris Zimmerle, Goshen, IN (US); David Brock, Elkhart, IN (US); Gary Krauth, Hopedale, MA (US)

Correspondence Address: Toby H Kusmer;McDermott Will & Emery, 28 State Street, Boston, MA, 02109, US

(21) Appl. No.: 10/556,658

(22) PCT Filed: Jun. 3, 2004
(86) PCT No.: PCT/US04/17344

§ 371 Date: Nov. 11, 2005

Related U.S. Application Data
(60) Provisional application No. 60/475,288, filed on Jun. 3, 2003.

(51) Int. Cl. G01N 21/00

(52) U.S. Cl. 422/55

(57) ABSTRACT

An apparatus for verifying proper operation of an optical inspection machine, including a row of colored segments that simulate reagent pads containing known types of analytes at known concentrations positioned so that the row of colored segments can be illuminated by the readhead of the optical inspection machine. If the optical inspection machine provides results that correspond to the known types and concentrations of analytes, then the machine is operating properly.

### CROSS-REFERENCE TO RELATED APPLICATIONS

The present application claims priority from co-pending provisional U.S. Patent Application Ser. No. 60/475,288, filed Jun. 3, 2003 (Attorney docket number BYRK-27PR), which is incorporated herein by reference in its entirety.

### FIELD OF THE DISCLOSURE

The present disclosure relates to an apparatus and method for verifying proper operation of an optical inspection machine. Even more particularly, the present disclosure relates to a verification cassette for establishing optical functionality of reflectance spectroscopy-based machines used in medical diagnostics.

### BACKGROUND OF THE DISCLOSURE

It is useful for various medical diagnostic purposes to utilize a reflectance spectroscope to analyze samples of body fluid, for example, to determine the color of a person's urine. As is known, spectroscopy uses the linear relationship between absorbance and concentration of an absorbing species (Beer's law), to determine the contents of a sample. An unknown concentration of an analyte can be determined by measuring the amount of light that a sample absorbs and applying Beer's law. If the absorptivity coefficient of the analyte is not known, the unknown concentration can be determined using a working curve of absorbance versus concentration derived from standards.

Reflectance spectroscopy is the study of light as a function of wavelength that has been reflected or scattered from a solid, liquid, or gas. A conventional reflectance spectroscope, often referred to as a “reflectometer,” may determine the color of a urine sample disposed on a white, non-reactive pad by illuminating the pad and taking a number of reflectance readings from the pad, each having a magnitude relating to a different wavelength of visible light. The color of the urine on the pad may then be determined based upon the relative magnitudes of red, green, blue and infrared reflectance signals. Reagent pads can be provided with different reactants or components which cause a specific color change in response to the presence of a certain type of constituent in urine, such as leukocytes (white blood cells) or red blood cells. A reagent strip may have ten or more different types of reagent pads, for example.

Some optical inspection machines use reflectance spectroscopy for medical diagnostic purposes. Many of these machines are small enough and inexpensive enough to be usable in physician offices and smaller laboratories, for example, and therefore are able to provide individual doctors, nurses and other caregivers with powerful medical diagnostic tools.

For example, U.S. Pat. No. 5,654,803, which is assigned to the assignee of the present disclosure, discloses an optical inspection machine for determining non-hemolyzed levels of occult blood in urine using reflectance spectroscopy. The machine is provided with a light source for successively illuminating a plurality of different portions of a reagent pad on which a urine sample is disposed, and a detector array for detecting light received from the reagent pad and generating a plurality of reflectance signals in response to light received from a corresponding one of the different portions of the reagent pad. The machine is also provided with means for determining whether the magnitude of one of the reflectance signals is substantially different than the magnitude of another of the reflectance signals. Where the body-fluid sample is urine, this capability allows the machine to detect the presence of non-hemolyzed levels of occult blood in the urine sample.

U.S. Pat. No. 5,877,863, which is also assigned to the assignee of the present disclosure, shows an optical inspection machine for inspecting a liquid sample, such as urine, using reflectance spectroscopy. The machine includes a readhead for illuminating a target area substantially uniformly via only a single light-emitting diode and receiving light from the target area so that reagent tests may be performed. The readhead is provided with a housing, first and second light sources mounted in a fixed position relative to the housing, a light guide mounted to receive light from each of the light sources which conveys, when only one of the light sources is illuminated, substantially all of the light from the light source to illuminate a target area substantially uniformly, and a light detector coupled to receive light from the target area. Each of the first and second light sources is composed of only a single light-emitting diode for emitting substantially monochromatic light of a different wavelength.

As mentioned above, such optical inspection machines provide individual doctors, nurses and other caregivers with powerful medical diagnostic tools. However, these optical inspection machines are not small enough to make shipping the machines (e.g., via the U.S. postal service, UPS, or Federal Express) between a physician's office or laboratory and the manufacturer convenient and inexpensive. Having a tool and method for verifying the performance of, or troubleshooting, a machine at the physician's office or laboratory, therefore, would be very desirable, and could prevent the unnecessary shipment of machines back to the manufacturer when incorrect readings are produced not by a malfunctioning or defective machine but by non-machine problems such as operator error or damaged or defective reagent strips.

Such a verification tool and method can also be used by the physician's office or laboratory as part of a quality control program to confirm proper operation of the optical inspection machine by conducting verification tests using the verification tool and method on a scheduled basis and record the results of each test. The verification tool and method may be used to verify proper operation of the following functions of the machine: optical train alignment, light emitting diode color accuracy, optical linearity, colored line detection and accuracy, and calibration strip precision. Results can also be used to correct for normal machine to machine variation to thereby increase the precision of results provided by each machine.

What is still desired, therefore, is a new and improved apparatus and method for verifying proper operation of an optical inspection machine, such as those used in medical diagnostics. Preferably, the new and improved apparatus and method will provide the ability to verify the operation of optical inspection machines using a compact, portable, easy-to-use and inexpensive device.

### SUMMARY OF THE DISCLOSURE

The disclosure is directed to exemplary embodiments of a new and improved apparatus and method for verifying proper operation of an optical inspection machine, such as those used in medical diagnostics.

One exemplary embodiment of the apparatus includes a row of colored segments that simulate reagent pads containing known types of analytes at known concentrations that are positioned so that the row of colored segments can be illuminated by the readhead of the optical inspection machine. If the optical inspection machine provides results that correspond to the known types and concentrations of analytes, then the machine is operating properly.

A method for verifying proper operation of the optical inspection machine according to the present disclosure generally includes inserting the apparatus into the optical inspection machine so that the row of colored segments can be illuminated by the readhead of the optical inspection machine. The optical inspection machine is then operated, and the results provided by the optical inspection machine are compared to the known types and concentrations of analytes simulated by the row of colored segments.

If the machine produces readings that match the known types and concentrations of analytes replicated by the row of colored segments, then the machine is operating properly and unexpected readings provided by the machine during normal use are produced not by a malfunction or defect of the machine, but by non-machine problems such as operator error or damaged or defective reagent strips. However, if the machine produces readings that do not match the known types and range of concentrations of analytes replicated by the row of colored segments, then the machine itself is malfunctioning, damaged or defective, and needs to be repaired.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is a perspective view of an exemplary embodiment of an optical inspection machine, which may be used to perform various tests of a body fluid sample;

FIG. 2 is an end perspective view of an exemplary embodiment of a tray assembly for use with the machine of FIG. 1, wherein the assembly includes a support tray and an insert, and wherein the insert is shown being positioned in the support tray with a first surface facing upwardly so that a reagent cassette may be held by the insert in the support tray;

FIG. 3 is an end perspective view of the assembly of FIG. 2, wherein the insert is shown being positioned in the support tray with a second surface facing upwardly so that a reagent strip may be held by the insert in the support tray;

FIG. 4 is a top plan view of a diagram illustrating a readhead of the optical inspection machine of FIG. 1;

FIG. 5 is a side elevation view of a diagram illustrating the readhead of FIG. 4;

FIG. 6 is a top plan view of an exemplary embodiment of a verification apparatus constructed in accordance with the present disclosure, which can be used, for example, verify proper operation of the optical inspection machine of FIG. 1;

FIG. 7 is an enlarged top plan view of an exemplary embodiment of a color printed insert of the verification apparatus of FIG. 6;

FIG. 8 is a top plan view of an exemplary embodiment of a top piece of the verification apparatus of FIG. 6;

FIG. 9 is a side elevation view of the top piece of the verification apparatus of FIG. 6;

FIG. 10 is a bottom plan view of the top piece of the verification apparatus of FIG. 6;

FIG. 11 is a sectional view of the top piece of the verification apparatus of FIG. 6 taken along line 11-11 of FIG. 10;

FIG. 12 is a sectional view of the top piece of the verification apparatus of FIG. 6 taken along line 12-12 of FIG. 10;

FIG. 13 is a bottom plan view of an exemplary embodiment of a bottom piece of the verification apparatus of FIG. 6;

FIG. 14 is a side elevation view of the bottom piece of the verification apparatus of FIG. 6;

FIG. 15 is a top plan view of the bottom piece of the verification apparatus of FIG. 6;

FIG. 16 is a sectional view of the bottom piece of the verification apparatus of FIG. 6 taken along line 16-16 of FIG. 15;

FIG. 17 is a sectional view of the bottom piece of the verification apparatus of FIG. 6 taken along line 17-17 of FIG. 10; and

FIG. 18 is an enlarged top plan view of a portion of the bottom piece of the verification apparatus of FIG. 6

### DETAILED DESCRIPTION OF EXEMPLARY EMBODIMENTS

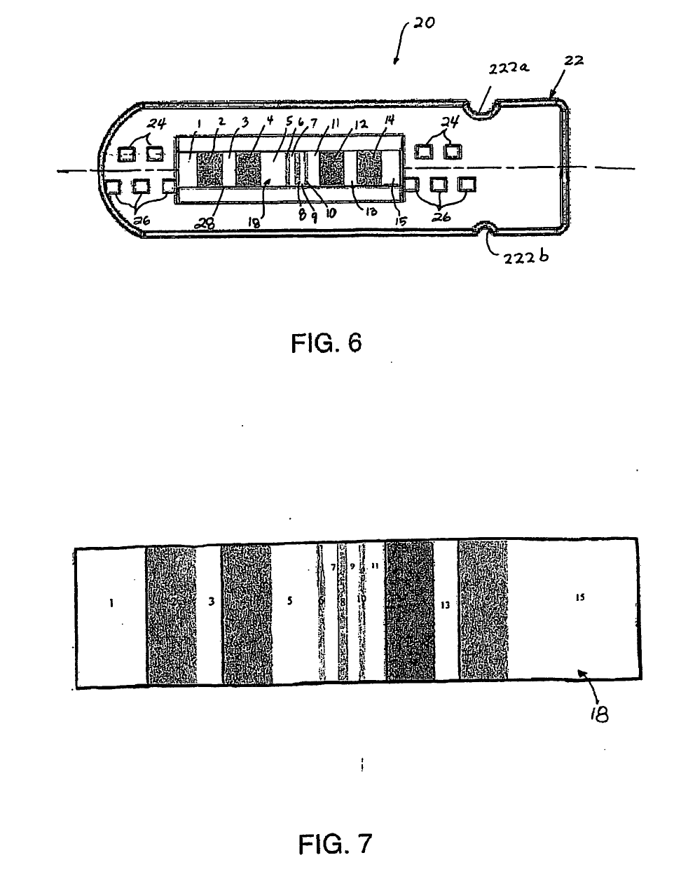

FIG. 6 shows an exemplary embodiment of a new and improved verification apparatus constructed in accordance with the present disclosure for use with a machine for optically inspecting samples of body fluid for medical diagnostic purposes. The verification apparatus is compact, portable, easy-to-use and inexpensive and is used to establish the optical functionality of optical inspection machines without having to move the machines.

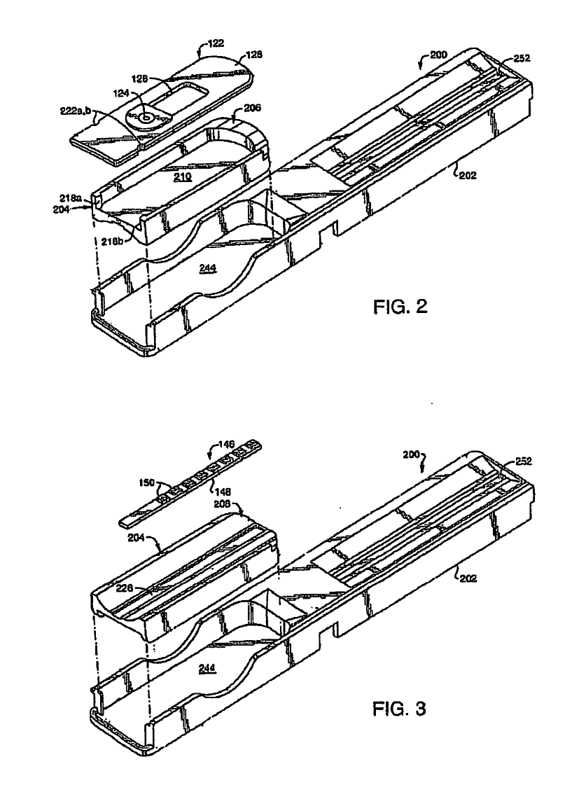

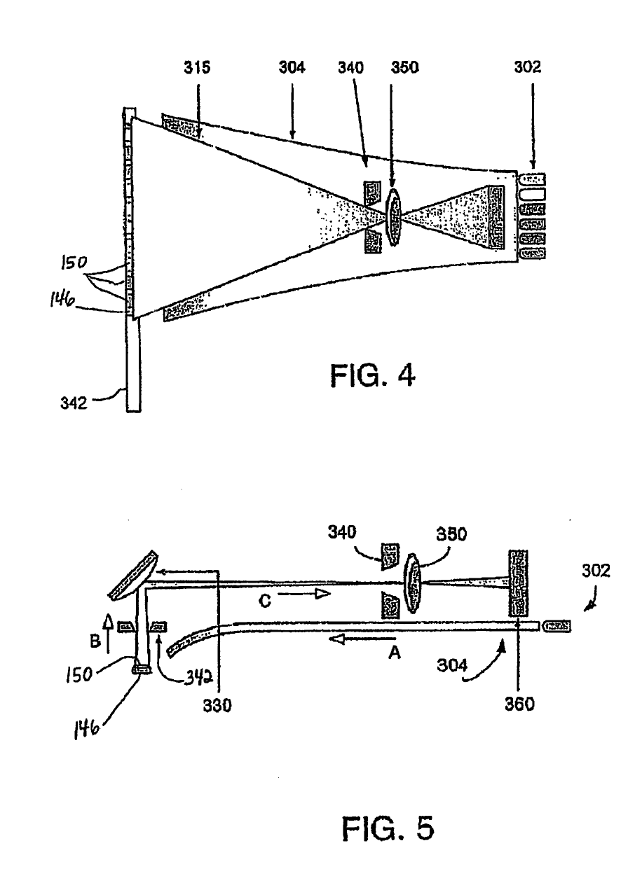

Prior to discussing the new and improved verification apparatus of FIG. 6, however, an optical inspection machine and components shown in FIGS. 2 through 5 will first be discussed to provide background information. The machine 100 of FIG. 2 is a reflectance spectroscope, or “reflectometer,” for optically inspecting liquid samples such as body fluid samples, placed on a liquid carrier, such as a reagent cassette 122 or a reagent strip 146, examples of which are shown in FIGS. 2 and 3, respectively. FIGS. 4 and 5 show an exemplary embodiment of a readhead 300 of the inspection machine 100.

Optical Inspection Machine

The particular optical inspection machine 100 shown in FIG. 2 is a CLINITEK STATUS® Urine Chemistry Analyzer available from Bayer Corporation, Diagnostics Division, of Tarrytown, N.Y. However, the new and improved VERIFICATION APPARATUS of the present disclosure can also be used with other optical inspection machines, such as the CLINITEK® 50 Urine Chemistry Analyzer, which is also available from Bayer Corporation, Diagnostics Division, of Tarrytown, N.Y., and which is described in U.S. Pat. Nos. 5,654,803; 5,945,341; and 6,239,445, which are assigned to the assignee of the present disclosure and incorporated herein by reference.

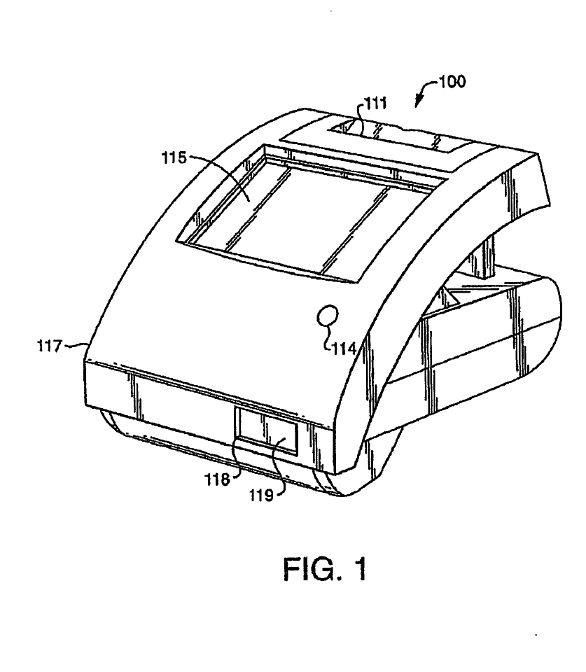

The inspection machine 100 of FIG. 1 generally includes a printer 111, an on/off switch 114, and a touch-screen display 115 for user input and for displaying various messages to a user relating to the operation of the inspection machine 100. The inspection machine 100 also has a housing 117 with an opening 118 formed therein into which a tray assembly 200 shown in FIGS. 2 and 3 may be retracted. The opening 118 includes a door 119 that opens upon the tray assembly 200 being extended out of the opening 118.

Reagent Cassette and Reagent Strip

The tray assembly 200 is for supporting the reagent cassette 122 or the reagent strip 146 as shown in FIGS. 2 and 3, and includes a support tray 202 and an insert 204 that fits into the support tray with one of a first surface 206, adapted to hold the reagent cassette 122, and a second surface 208, adapted to hold the reagent strip 146, facing upwardly so that one of the reagent cassette 122 and the reagent strip 146 can be held by the insert 204 in the support tray 202. The tray assembly 200 is described in greater detail in co-owned and co-pending U.S. patent application Ser. No. 10/821,441, filed on Apr. 9, 2004 (Attorney Docket Reference BYRK-023), which also claims priority to provisional patent application Ser. No. 60/475,288 (BYRK-27PR), filed Jun. 3, 2003 and is incorporated herein by reference.

Referring to FIG. 2, the reagent cassette 122 may be a disposable, single-use cassette for doing a lateral flow pregnancy immunoassay test, for example, in the conventional manner. The reagent cassette 122 has an opening or well 124 into which a body fluid sample, such as urine, is placed. The interior of the reagent cassette 122 has a reagent strip (not shown) which may react with the body fluid sample placed in the well 124. Depending on the results of the test, the reagent strip may change color (e.g., a colored stripe may appear), which is determinable from viewing the reagent strip through a window 128 formed in the reagent cassette 122.

Referring to FIG. 3, the reagent strip 146 may have a thin, non-reactive substrate 148 on which a number of reagent pads 150 are fixed. Each reagent pad 150 may be composed of a relatively absorbent material impregnated with a respective reagent, each reagent and reagent pad 150 being associated with a particular test to be performed. When urinalysis tests are performed, they may include, for example, a test for leukocytes in the urine, a test of the pH of the urine, a test for blood in the urine, etc. When each reagent pad 50 comes into contact with a urine sample, the pad changes color over a time period, depending on the reagent used and the characteristics of the urine sample. The reagent strip 146 may be, for example, a MULTISTIX® reagent strip commercially available from Bayer Corporation, Diagnostics Division, of Tarrytown, N.Y., and the reagent strip 146 may include, but is not limited to, reagent pads 150 for: Leukocytes, Glucose, Bilirubin, Ketone, Specific Gravity, Nitrite, pH, Protein, Urobilinogen, Blood, Albumin and Creatinine.

During use, the insert 204 of the tray assembly 200 of the present disclosure is removable from the support tray 202 and can be turned over and re-inserted into the support tray 202 depending upon which of the reagent cassette 122 and the reagent strip 146 is to be used with the tray assembly 200. Referring to FIG. 2, the surface 206 of the insert 204 has a recess 210 shaped to receive the reagent cassette 122. An end wall of the recess 210 is curved to match a curved end wall of the reagent cassette 122, to ensure that a user correctly orients the reagent cassette 122 within the insert 204. The insert 204 also includes orientation features such as bosses 218a, 218b that are received in, respectively, indents 222a, 222b in the reagent cassette 122 to prevent the reagent cassette 122 from sliding out of the insert 204. Alternatively, the bosses can be provided on the reagent cassette 122 and the indents in the insert 204. The bosses 218a, 218b of the recess 210 are provided in slightly different sizes or shapes, and the indents 222a, 222b of the reagent cassette 122 are also provided in slightly different sizes or shapes, which match the bosses 218a, 218b, to prevent the reagent cassette 122 from being inserted into the insert 204 upside down.

Referring to FIG. 3, a second surface 208 of the insert 204 has an elongated channel 226 sized to accommodate the reagent strip 146. As shown in FIGS. 2 and 3, the support tray 202 includes a compartment 244 for receiving the insert 204, and an elongated channel 252 for receiving a white calibration strip (not shown).

During an inspection procedure the tray assembly 200 and one of a reagent cassette 122 and a reagent strip 146 is moved between an outwardly extended position and an optical inspection position in which the tray assembly 200 is retracted inwardly into the housing 117 of the inspection machine 100 and into the readhead 300 of the machine.

Readhead

Referring to the exemplary embodiment of FIGS. 4 and 5, the readhead 300 includes light-emitting diodes (LEDs) 302 for transmitting a different signal having a unique wavelength. In this exemplary embodiment, the signals transmitted by the LEDs are blue light at a wavelength of about 470 nanometers (nm), green light at a wavelength of about 525 nm, green light at a wavelength of about 565 nm, red light at a wavelength of about 625 nm, red light at a wavelength of about 660 mn, and an infrared (IR) signal at a wavelength of about 845 nm. (It should be understood that these wavelengths are approximate, and that the manufacturer must provide LEDs within a specified range which is LED-specific.) In operation, only one of the LEDs 302 is illuminated at a time, and the illumination provided by that single LED 302 is sufficient to uniformly illuminate the reagent strip 146 to an extent that allows a detector array 360 to detect enough light from the reagent strip 146 to have the reagent tests described above satisfactorily performed.

Test signals from the LEDs 302 are transmitted through a guide 304 in the direction of arrow A, as shown in FIG. 5. The test signals from the guide 304 impinge on one of a reagent cassette or a reagent strip positioned in the readhead 300 on the tray assembly (not shown in FIGS. 4 and 5). In FIGS. 4 and 5, a reagent strip 146 is shown positioned in the readhead 300. Light reflected from the test strip in the direction of arrow B, as shown in FIG. 5, passes through an aperture 342, after which it impinges on convex mirror 330 (not shown in FIG. 4), which redirects and focuses the reflected signals in the direction of arrow C, as shown in FIG. 5. In this arrangement, due to the orientation of mirror 330, the path of the reflected signals takes a 90° turn after leaving the test strip 146. The reflected signals propagating in the direction of arrow C pass through aperture 340 and converge at aspheric lens 350. Aspheric lens 350 diverges the reflected signals and the diverged reflected signals continue to propagate in the direction of arrow C. The reflected signals impinge on the detector 360. As will be appreciated by those skilled in the art, the shapes and arrangement of mirrors and lenses need not specifically conform to or be limited to those shown in the illustrative embodiment of FIGS. 4 and 5.

The detector 360 receives the reflected signals, translates them into an image comprised of data representing reflectance values associated with the test pads 150. According to one exemplary embodiment, the detector 360 is a charge coupled device (CCD) comprised of a linear arrangement of 2048 pixels configured to receive the reflected signals. Data from the reflected signals is recorded pixel-by-pixel as the reflectance values. Pixel data are grouped and associated with individual pads 150 on the test strip 146. As a result, the test strip is imaged and reflectance values for each pad is determined.

The received reflected signals are translated into digital data representing reflectance values, as an “image” of the test strip. Each reflectance value is a function of the wavelength of the light transmitted from the source and the make-up of the test pad from which the signal was reflected. Different test pads have different spectral signatures. A spectral signature is a plot of reflectance (e.g., as a percentage) versus wavelength for a given material. Therefore, given a wavelength and a set of spectral signatures (comprising reference reflectance values), a material (e.g., test pad) associated with a given reflectance value can be determined by comparing that reflectance value with the reference reflectance values from the set of spectral signatures for the given wavelength. The verification apparatus 20 and method for verifying provided by the present invention are used to ensure that the readhead 300 is functioning properly.

Verification Apparatus and Method

The present disclosure provides a new and improved verification apparatus and method for verifying proper operation of an optical inspection machine. Referring to FIG. 6, an exemplary embodiment of the verification apparatus 20 is shown. In general, the verification apparatus 20 includes a housing 22 adapted to be received within the readhead 300 of the optical inspection machine 100. The verification apparatus 20 also includes a row of colored segments 1-15, which is also shown in FIG. 7, that simulate reagent pads containing known types of analytes at known concentrations. The row of colored segments 1-15 is positioned on the housing 22 so that the segments 1-15 can be illuminated by the LEDs of the readhead 300 of the optical inspection machine 100.

A method for verifying proper operation of the optical inspection machine 100 according to the present disclosure generally includes inserting the apparatus 20 using the tray assembly 200, into the optical inspection machine 100 so that the row of colored segments 1-15 can be illuminated by the readhead 300 of the optical inspection machine. The optical inspection machine 100 is then operated, and the results provided by the optical inspection machine 100 are compared to the known types and concentrations of analytes simulated by the row of colored segments. If the machine 100 produces readings that match the known types and concentrations of analytes replicated by the row of colored segments, then it will be known that the machine is operating properly and incorrect readings provided by the machine during normal use are produced not by a malfunction or defect of the machine, but by non-machine problems such as operator error or damaged or defective reagent strips. However, if the machine 100 produces readings that do not match the known types and concentrations of analytes replicated by the row of colored segments, then it will be known that the machine itself is malfunctioning, damaged or defective, and needs to be repaired.

The verification apparatus and method of the present disclosure can be used to verify the performance of, or troubleshoot, an optical inspection machine at a physician's office or laboratory. The verification apparatus and method is intended to prevent the unnecessary shipment of machines back to the manufacturer when incorrect readings are produced not by a malfunctioning or defective machine but by non-machine problems such as operator error or damaged or defective reagent strips. The verification apparatus and method may be used to verify proper operation of the following functions of the machine: the machine's optical train alignment, the machine's light emitting diode color accuracy, the machine's optical linearity, colored stripe detection and accuracy, and the machine's calibration strip precision.

The verification apparatus and method can also be used by the physician's office or laboratory as a quality control program to confirm proper operation of the optical inspection machine by conducting verification tests using the verification apparatus and method on a scheduled basis and recording the results of each test. In addition, the results can be used to correct for normal machine to machine variation to thereby increase the precision of results provided by each machine.

As shown in FIG. 6, the housing also includes offset parallel rows of indicators 24, 26 extending from ends of the row of colored segments 1-15. The indicators 24, 26 are a color that contrasts with the housing. In the exemplary embodiment shown, the indicators 24, 26 comprise bosses having flat top surfaces, wherein the flat top surfaces of the indicators 24, 26 are square and colored black, or another color that contrasts with the housing. The offset, parallel rows of indicators 24, 26 are used to confirm that an optical train of the optical inspection machine 100 is properly aligned.

In the exemplary embodiment shown in FIGS. 6 and 7, the rows of colored segments 1-15 are provided on an insert 18 secured within the housing 22, and the housing includes a window 28 for allowing the insert to be illuminated by the readhead of the optical inspection machine. According to one exemplary embodiment, the insert 18 is made from paper and the colored segments are 1-15 printed ink.

Still referring to FIGS. 6 and 7, the even-numbered colored segments 2, 4, 6, 8, 10, 12, 14 are non-white colored and separated by the odd-numbered colored segments 1, 3, 5, 7, 9, 11, 13, 15, which are colored white. In the exemplary embodiment shown, the non-white colored segments include three red colored stripes 6, 8, 10 of different intensities, which are used to confirm that colored stripe detection and amplitude accuracy of the optical inspection machine is correct. It should be understood, that the stripes which are used to confirm that colored stripe detection and amplitude accuracy of the optical inspection machine is correct can comprise more or less than three stripes and that the stripes can be a color(s) other than red.

In the exemplary embodiment shown, the non-white colored segments also include orange, green and aqua colored bands 2, 4, 14, respectively, which are used to confirm that an LED characterization of the optical inspection machine is correct. In the exemplary embodiment shown, the non-white colored segments further include a gray band 12 used to confirm that a detector linearity of the optical inspection machine is correct. More than one gray band of varying intensities may be provided.

In the exemplary embodiment shown in FIG. 6, the verification apparatus 20 is similar in shape and size to the reagent cassette 122 of FIG. 2, such that the apparatus 20 can be used with the tray assembly 200 of FIG. 2. In particular, the housing 22 of the apparatus 20 includes orientation features such as indents 222a, 222b that receive the bosses 218a, 218b of the insert 204 of the tray assembly 200 (shown in FIG. 2) to prevent the apparatus 20 from sliding out of the insert 204 and to ensure that the apparatus 20 is correctly oriented in the insert 204. Alternatively, the bosses can be provided on the apparatus 20 and the indents in the insert 204. The bosses 218a, 218b and the indents 222a, 222b are provided in slightly different sizes or shapes to prevent the apparatus 20 from being inserted into the tray assembly 200 upside down.

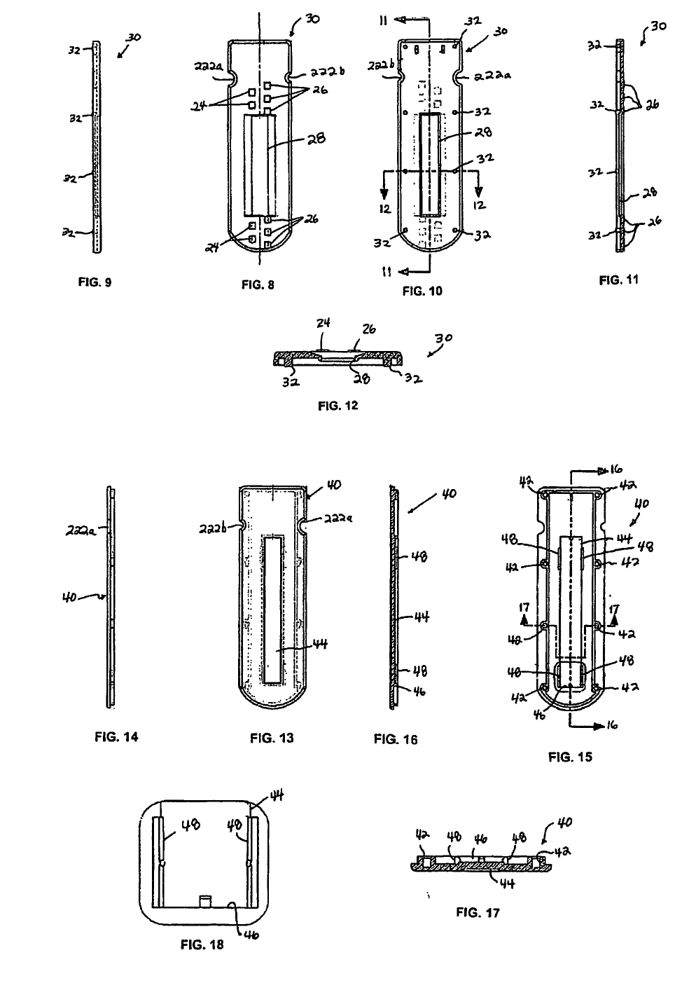

The housing 22 of the apparatus 20 includes a top piece 30, as shown in FIGS. 8-12, which defines the window 28 for allowing the insert 18 to be illuminated by the readhead of the optical inspection machine, and a bottom piece 40, shown in FIGS. 13-18. During assembly of the housing 22, the bottom piece 40 is secured to the top piece 30 with the insert 18 secured between the top and the bottom pieces. The pieces can be secured together, for example, in a snap-fit manner using prongs 32 of the top piece 30, which are received in corresponding bores 42 of the bottom piece 40. As shown in FIGS. 13 and 15-18, the bottom piece 40 includes a platform 44, an end wall 46 and side walls 48 extending toward the top piece 30, and that act to correctly position the insert 18 with respect to the window 28 of the top piece 30 upon assembly of the housing 22.

Numerous further modifications and alternative embodiments of the disclosure will be apparent to those skilled in the art in view of the foregoing description. For example, although the exemplary embodiment of the apparatus 20 shown in FIG. 6 includes a housing 22, it should be understood that a verification apparatus constructed in accordance with the present disclosure does not have to include a housing but can simply comprise a strip similar to the test strip 146 shown in FIG. 3. In such an embodiment, the apparatus could comprise an elongated strip of paper (or other suitable material) with the colored segments 1-15 and the indicators 24, 26 printed thereon with ink (or another suitable printing material). The exemplary embodiments shown and discussed in this specification are therefore to be construed as illustrative only, and are for the purpose of teaching those skilled in the art the best modes of carrying out the disclosure. The details of the apparatus and method may be varied substantially without departing from the spirit of this disclosure, and the exclusive use of all modifications which come within the scope of the appended claims is reserved.

What is claimed is:

1. An apparatus for verifying proper operation of an optical inspection machine, comprising:
a row of colored segments that simulate reagent pads containing known types of analytes at known concentrations, wherein the row of colored segments are positioned so that segments can be illuminated by the readhead of the optical inspection machine.

2. An apparatus as defined in claim 1, further comprising offset parallel rows of indicators extending from ends of the row of colored segments.

3. An apparatus as defined in claim 2, wherein the indicators comprise bosses having flat top surfaces.

4. An apparatus as defined in claim 2, wherein the indicators are colored black.

5. An apparatus as defined in claim 2, wherein the indicators are square.

6. An apparatus as defined in claim 2, wherein the indicators are used to confirm that an optical train of an optical inspection machine is properly aligned.

7. An apparatus as defined in claim 1, wherein the row of colored segments are provided on an insert secured to a housing.

8. An apparatus as defined in claim 7, wherein the insert is secured within the housing and the housing includes a window for allowing the insert to be illuminated by the readhead of the optical inspection machine.

9. An apparatus as defined in claim 7, wherein the insert is made from paper.

10. An apparatus as defined in claim 9, wherein the colored segments are printed ink.

11. An apparatus as defined in claim 1, wherein the colored segments include non-white colored segments separated by white segments.

12. An apparatus as defined in claim 11, wherein the non-white colored segments include colored stripes used to confirm that colored stripe detection and amplitude accuracy of an optical inspection machine is correct.

13. An apparatus as defined in claim 11, wherein the non-white colored segments include orange, green and aqua colored bands used to confirm that a LED characterization of an optical inspection machine is correct.

14. An apparatus as defined in claim 11, wherein the non-white colored segments include gray bands of varying intensities used to confirm that a detector linearity of an optical inspection machine is correct.

15. An apparatus as defined in claim 7, wherein the housing includes orientation features that mate with orientation features of a tray assembly for guiding the apparatus into the optical inspection machine, so that the apparatus can be correctly oriented in the tray assembly.

16. An apparatus as defined in claim 15, wherein the orientation features include different sized indents positioned to receive corresponding different sized bosses of the tray assembly when the apparatus is correctly oriented in the tray assembly.

17. An apparatus as defined in claim 1, further comprising a tray assembly including a support tray for insertion into an optical inspection machine and an insert that fits into the support tray, and wherein the insert has a surface contoured to receive the verification apparatus.

18. A system including the apparatus and tray assembly of claim 17, and further including an optical inspection machine comprising:
an opening into which the tray assembly and the apparatus are retracted;
an inspection location within the opening for receiving the apparatus;
a light source for illuminating the apparatus when the apparatus is received in the inspection location; and
a detector for receiving light reflected off the apparatus from the light source.

19. A system including the apparatus of claim 1, and further including an optical inspection machine comprising:
an opening into which the apparatus is retracted;
an inspection location within the opening for receiving the apparatus;
a light source for illuminating the apparatus when the apparatus is received in the inspection location; and
a detector for receiving light reflected off the apparatus from the light source.

20. A system as defined in claim 19, wherein the light source comprises LEDs providing different wavelengths.

21. A method for verifying proper operation of an optical inspection machine, comprising:
inserting an apparatus having a row of colored segments that simulate reagent pads containing known types of analytes at known concentrations into the optical inspection machine so that the row of colored segments can be illuminated by the readhead of the optical inspection machine;
operating the optical inspection machine; and
comparing the results provided by the optical inspection machine to the known types and concentrations of analytes simulated by the row of colored segments.

22. A method as defined in claim 21, further comprising positioning offset parallel rows of indicators on the apparatus so that the indicators extend from opposite ends of the row of colored segments, and using the indicators to confirm that an optical train of the optical inspection machine is properly aligned.

23. A method as defined in claim 21, wherein the row of colored segments are provided on an insert secured to the apparatus, wherein the insert is made from paper and the colored segments are printed ink.

24. A method as defined in claim 21, wherein the colored segments include non-white colored segments separated by white segments.

25. A method as defined in claim 24, wherein the non-white colored segments include colored stripes used to confirm that colored stripe detection and amplitude accuracy of the optical inspection machine is correct.

26. A method as defined in claim 24, wherein the non-white colored segments include orange, green and aqua colored bands that are used to confirm that a LED characterization of the optical inspection machine is correct.

27. A method as defined in claim 24, wherein the non-white colored segments include gray bands of varying intensities that is used to confirm that a detector linearity of the optical inspection machine is correct.

28. A method as defined in claim 21, wherein the method is repeated on a predetermined basis and the results provided by the optical inspection machine recorded.

29. An apparatus as defined in claim 8, wherein the housing comprises:
a top piece defining the window for allowing the insert to be illuminated by the readhead of the optical inspection machine; and
a bottom piece secured to the top piece with the insert secured between the top and the bottom pieces, wherein the bottom piece includes an end wall and side walls extending toward the top piece and that correctly position the insert with respect to the window of the top piece.

30. An apparatus as defined in claim 29, wherein the top piece of the housing includes on a top surface thereof offset parallel rows of bosses extending from opposite ends of the window.
